(19) United States
(12) Patent Application Publication
(10) Pub. No.: US 2008/0024046 A1
(43) Pub. Date: Jan. 31, 2008

(54) POSITIONING DEVICE ADAPTED FOR POSITIONING A DETACHABLE MODULE IN A HOUSING

(76) Inventor: Xia JUAN, Shanghai City (CN)

Correspondence Address: OSTROLENK FABER GERB & SOFFEN, 1180 AVENUE OF THE AMERICAS, NEW YORK, NY, 100368403, US

(21) Appl. No.: 11/681,317

(22) Filed: Mar. 2, 2007

(30) Foreign Application Priority Data
Jul. 26, 2006 (TW) 095213137

(51) Int. Cl. A47B 95/02; G11B 17/025

(52) U.S. Cl. 312/332.1

(57) ABSTRACT

A positioning device includes two guiding members fixed spacedly in a housing. Each guiding member has a hook-shaped guiding slot having an elongate first slot portion, and a curved second slot portion defined by parallel first and second guiding faces. A pivot member is connected pivotally to a detachable module. Two positioning rods of the pivot member are guided respectively by the first slot portions to move rearwardly as a result of rearward movement of the detachable module until the positioning rods abut respectively against the first guiding faces. The pivot member may then be pivoted such that the positioning rods are in slidable contact with the second guiding faces, and move along the second slot portions, respectively, thereby resulting in further rearward movement of the detachable module by a predetermined distance.

### CROSS-REFERENCE TO RELATED APPLICATION

This application claims priority of Taiwanese Application No. 09521313, filed on Jul. 26, 2006.

### BACKGROUND OF THE INVENTION

1. Field of the Invention

The invention relates to a positioning device, more particularly to a positioning device adapted for positioning a detachable module in a housing.

2. Description of the Related Art

Currently, a hot-plug electronic device, such as JBOD (Just Bundle of Disks), RAID (Redundant Array of Independent Disks), etc., is manually assembled to and disassembled from a connecter in a housing. Improper operation during manual manipulation may result in damage to the connector, thereby adversely affecting electrical connection between the connector and the electronic device.

### SUMMARY OF THE INVENTION

Therefore, the object of the present invention is to provide a positioning device that enables a detachable module to be easily positioned in and detached from a housing and that can ensure appropriate electrical connection between a connector of the detachable module and a connecting port of the housing.

According to the present invention, there is provided a positioning device adapted for positioning a detachable module in a housing. The housing has a front open side. The positioning device comprises:

a pair of guiding members adapted to be mounted fixedly in the housing and spaced apart from each other in a direction, each of the guiding members being formed with a hook-shaped guiding slot, the guiding slot in each of the guiding members having an elongate first slot portion that extends rearwardly from a front end of a corresponding one of the guiding members, and a curved second slot portion connected to the first slot portion and extending downwardly and frontwardly from a rear end of the first slot portion, each of the guiding members having curved first and second guiding faces parallel to each other and defining the second slot portion of the guiding slot in the corresponding one of the guiding members therebetween; and

a pivot member adapted to be mounted pivotally on the detachable module such that the pivot member is pivotable relative to the detachable module about an axis parallel to the direction, the pivot member having opposite pivot blocks adapted to be connected respectively and pivotally to opposite lateral sides of the detachable module, each of the pivot blocks being disposed between a corresponding one of the guiding members and the detachable module when the detachable module is inserted into the housing via the front open side, each of the pivot blocks having an integral positioning rod that extends outwardly in the direction and that has a diameter substantially equal to a distance between the first and second guiding faces of the corresponding one of the guiding members.

During assembly of the detachable module to the housing, initially, the positioning rods of the pivot blocks of the pivot member are guided respectively by the first slot portions of the guiding slots in the guiding members to move rearwardly as a result of rearward movement of the detachable module until the positioning rod of each of the pivot blocks of the pivot member abuts against the first guiding face of the corresponding one of the guiding members, and subsequently, the pivot member is operable so as to pivot the pivot blocks of the pivot member such that the positioning rod of each of the pivot blocks of the pivot member is in slidable contact with the second guiding faces of the corresponding one of the guiding members, and moves along the second slot portion of the corresponding one of the guiding members, thereby resulting in further rearward movement of the detachable module by a predetermined distance in response to continuous pivoting of the pivot member.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view illustrating the preferred embodiment of a positioning device adapted for positioning a detachable module in a housing according to the present invention;

FIG. 2 is a fragmentary perspective view showing the preferred embodiment when the detachable module is inserted into the housing;

FIGS. 3 to 7 are fragmentary schematic side views showing the preferred embodiment during assembly of the detachable module to the housing;

FIG. 8 is a schematic view illustrating a moving trace of a positioning rod of the preferred embodiment during assembly of the detachable module to the housing; and

FIG. 9 is a schematic view illustrating a moving trace of the positioning rod of the preferred embodiment during disassembly of the detachable module from the housing.

### DETAILED DESCRIPTION OF THE PREFERRED EMBODIMENT

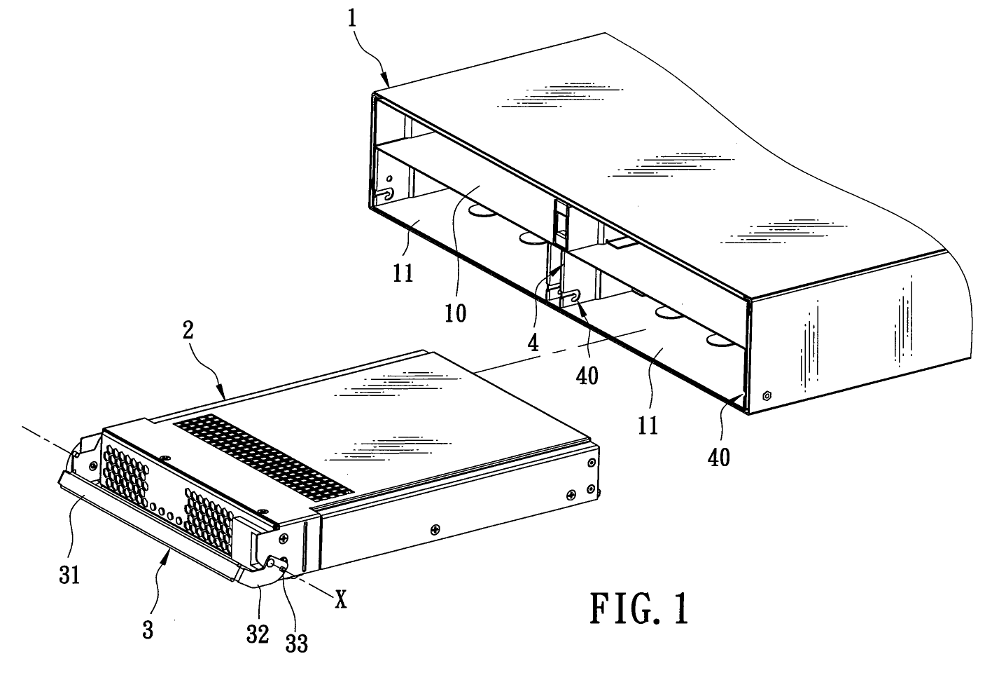

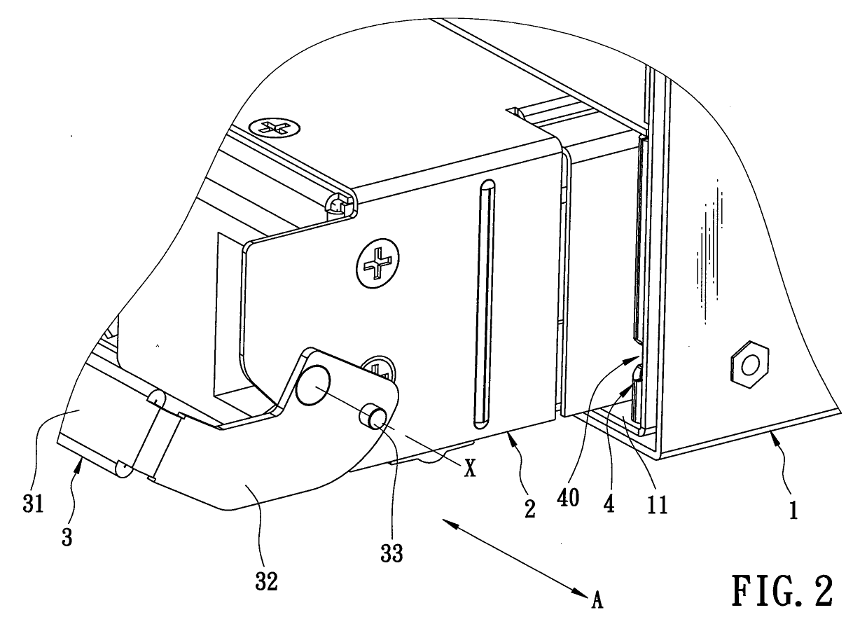

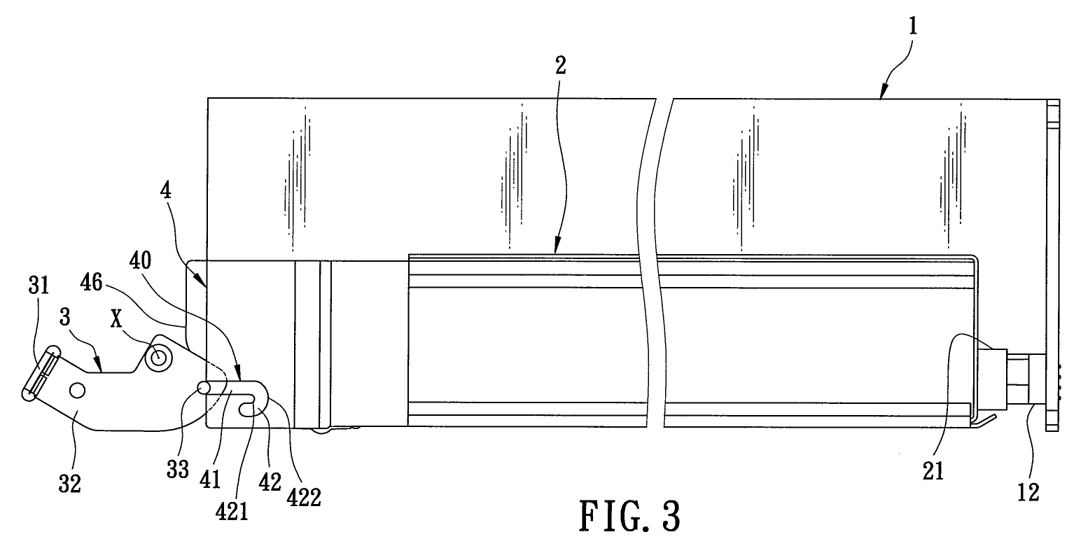

Referring to FIGS. 1 to 3, the preferred embodiment of a positioning device according to the present invention is shown to be adapted for positioning a detachable module 2 in a housing 1. In this embodiment, the housing 1 has a front open side 10, and is configured with four insertion grooves 11. The housing 1 further has a plurality of connecting ports 12 (only one is shown in FIG. 3) disposed adjacent to a rear side thereof and corresponding respectively to the insertion grooves 11. The detachable module 2 has a connector 21. When the detachable module 2 is positioned in a selected one of the insertion grooves 11 in the housing 1, the connector 21 of the detachable module 2 is connected electrically to a corresponding one of the connecting ports 12. The positioning device includes a pair of guiding members 4 and a pivot member 3.

The guiding members 4 are adapted to be mounted fixedly in the housing 1, and are spaced apart from each other in a direction (A). In this embodiment, each guiding member 4 is in the form of a plate body that can serve as a groove-defining wall for defining the selected one of the insertion grooves 11. Each guiding member 4 is formed with a hook-shaped guiding slot 40. For each guiding member 4, the guiding slot 40 has an elongate first slot portion 41 that extends rearwardly from a front end 46 of the plate body, and a curved second slot portion 42 connected to the first slot portion 41 and extending downwardly and frontwardly from a rear end of the first slot portion 41. Each guiding member 4 has first and second guiding faces 422, 421 parallel to each other and defining the second slot portion 42 of the guiding slot 40 in the corresponding one of the guiding members 4 therebetween, as shown in FIG. 3.

The pivot member 3 is adapted to be mounted pivotally on the detachable module 2 such that the pivot member 3 is pivotable relative to the detachable module 2 about a pivot axis (X) parallel to the direction (A). In this embodiment, the pivot member 3 has opposite pivot blocks 32 adapted to be connected respectively and pivotally to opposite lateral sides of the detachable module 2, and an intermediate handgrip 31 interconnecting fixedly the pivot blocks 32. Each pivot block 32 is disposed between a corresponding one of the guiding members 4 and the detachable module 2 when the detachable module 2 is inserted into the selected one of the insertion grooves 11 in the housing 1 via the front open side 10. Each pivot block 32 has an integral positioning rod 33 that extends outwardly in the direction (A).

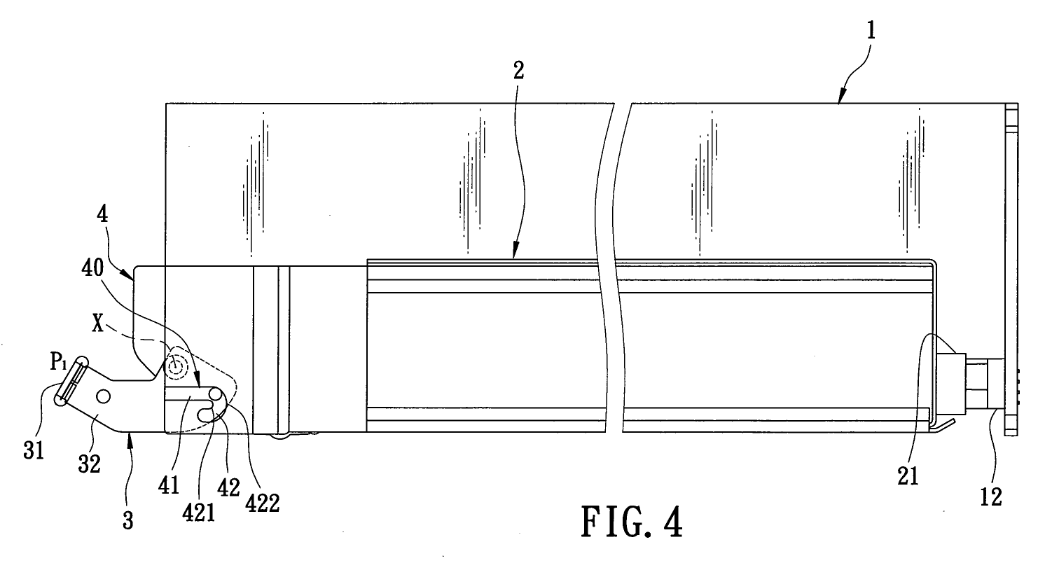

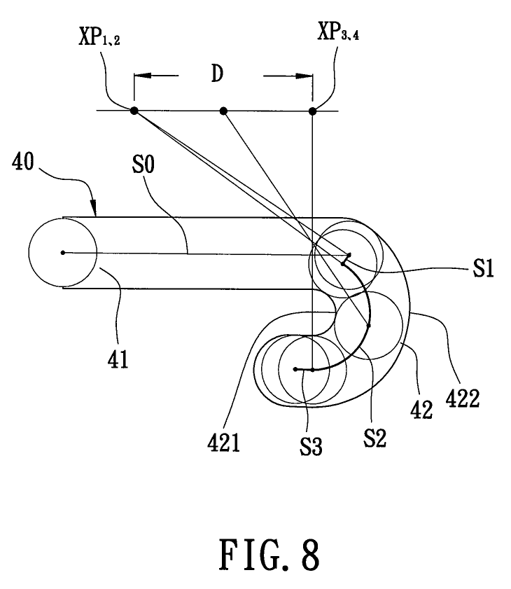

Referring further to FIGS. 4 to 7, during assembly of the detachable module 2 to the housing 1, after insertion of the detachable module 2 into the selected insertion groove 11 in the housing 1 via the front open side 10, initially, the positioning rods 33 of the pivot blocks 32 of the pivot member 3 are guided respectively by the first slot portions 41 of the guiding slots 40 in the guiding members 4 to move rearwardly toward the corresponding connecting port 12 as a result of continuous rearward movement of the detachable module 2 until the positioning rod 33 of each pivot block 32 of the pivot member 3 abuts against an upper portion of the first guiding face 422 of the corresponding guiding member 3, as shown in FIG. 4. In other words, the positioning rod 33 of each pivoting block 32 of the pivot member 3 moves along a path (S0) (see FIG. 8) to the position shown in FIG. 4. At the same time, the connector 21 of the detachable module 2 contacts merely but is not connected electrically to the selected connecting port 12.

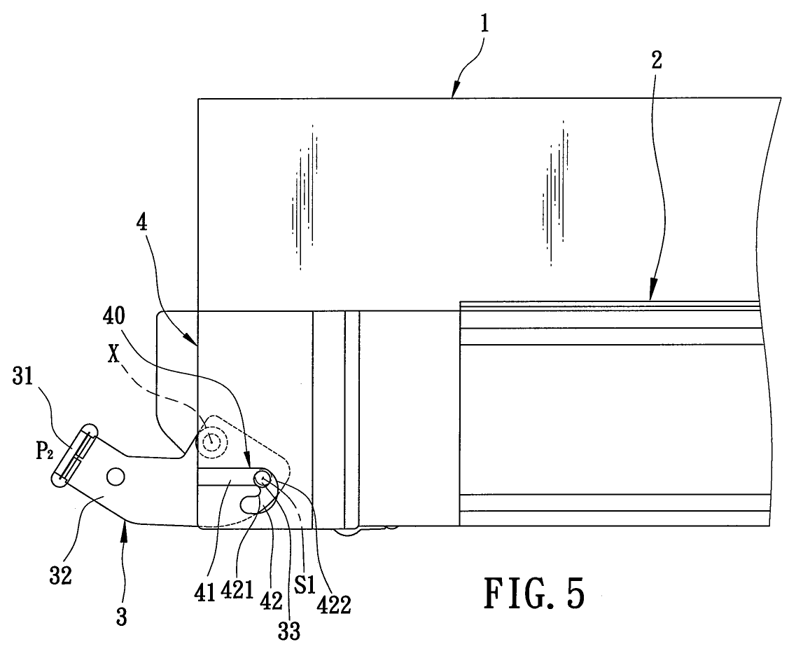

Subsequently, the pivot member 3 is pivoted about the pivot axis (X) in a clockwise direction from an initial first position (P₁) of FIG. 4 to an intermediate second position (P₂) of FIG. 5 so as to pivot the pivot blocks 32 such that the positioning rods 33 of the pivot blocks 32 of the pivot member 3 move downwardly and frontwardly until the positioning rod 33 of each pivot block 32 of the pivot member 3 abuts respectively against an upper end portion of the second guiding face 421 of the corresponding guiding member 4, as shown in FIG. 5. In other words, during pivoting of the pivot member 3 from the first position (P₁) to the second position (P₂), the positioning rod 33 of each pivoting block 32 of the pivot member 3 moves along a path (S1), as best shown in FIG. 8. It is noted that, during movement of the positioning rods 33 along the path (S1), the pivot axis (X) stays in the position (XP_{1,2}) so as to buffer movement of the detachable module 2 toward the selected connecting port 12 of the housing 1.

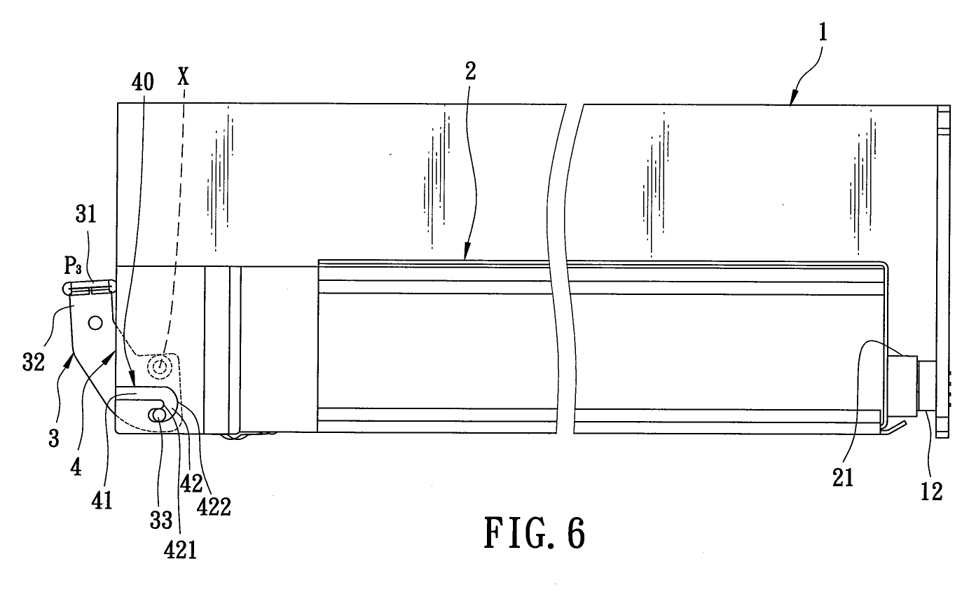

Next, the pivot member 3 is continuously pivoted about the pivot axis (X) in the clockwise direction from the second position (P₂) to an intermediate third position (P₃) of FIG. 6 such that the positioning rod 33 of each pivoting block 32 of the pivot member 3 is in slidable contact with the second guiding face 421 of the corresponding guiding member 4, and moves along the second slot portion 42 of the guiding slot 40 in the corresponding guiding member 4, thereby resulting in further rearward movement of the detachable module 2 by a predetermined distance (D), as shown in FIG. 8. In other words, during pivoting of the pivot member 3 from the second position (P₂) to the third position (P₃), the positioning rod 33 of each pivoting block 32 of the pivot member 3 moves along a path (S2), as best shown in FIG. 8. It is noted that the predetermined distance (D) is equal to a movement distance of the pivot axis (X) from a position (XP_{1,2}), where the pivot member 3 is in one of the first and second positions (P₁, P₂), to the position (XP_{3,4}), where the pivot member 3 is in the third position (P₃), as shown in FIG. 8. At this time, due to the further rearward movement of the detachable module 2 by the predetermined distance (D), the connector 21 of the detachable module 2 is connected electrically to the selected connecting port 12 of the housing 1 (see FIG. 6).

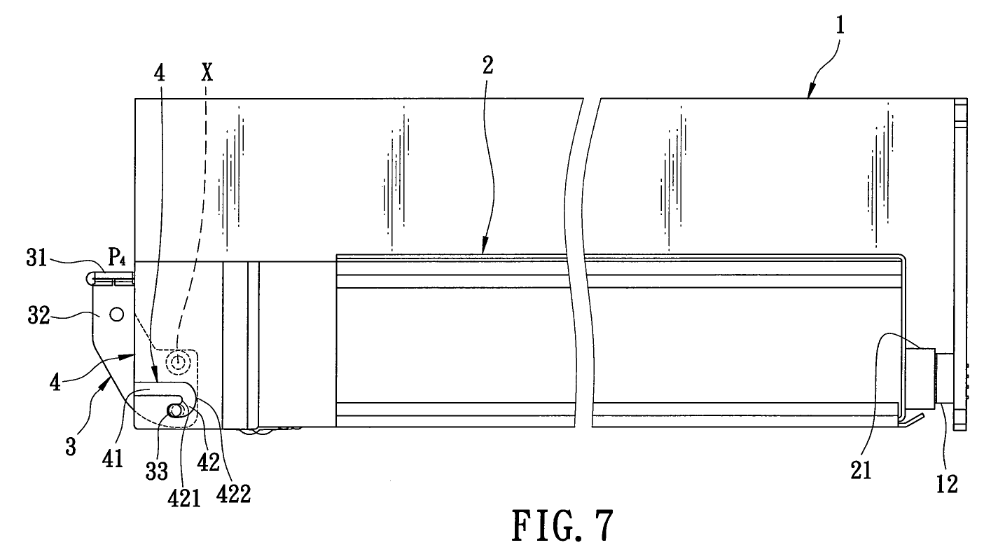

Thereafter, the pivot member 3 is continuously pivoted about the pivot axis (X) in the clockwise direction from the third position (P₃) to a final fourth position (P₄) of FIG. 7. As a result, since the positioning rod 33 of each pivoting block 32 of the pivot member 3 abuts against a lower portion of the front guiding face 421 of the corresponding guiding member 4, the positioning rod 33 of each pivoting block 32 of the pivot member 3 moves along a path (S3), as best shown in FIG. 8. It is noted that, during movement of the positioning rods 33 along the path (S3), the pivot axis (X) always stays in the position (XP_{3,4}).

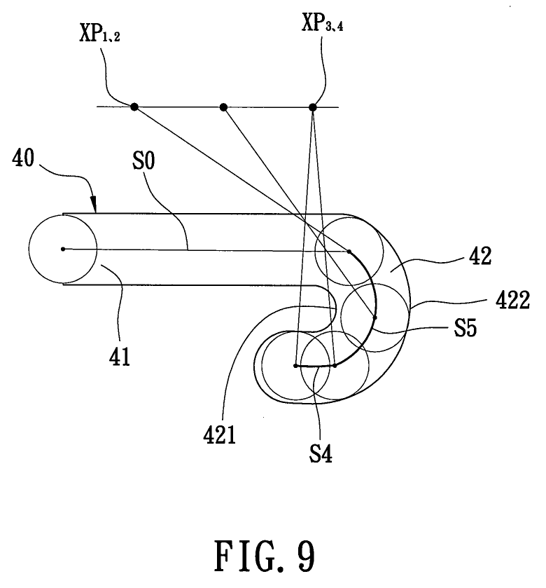

Referring further to FIG. 9, during disassembly of the detachable module 2 from the housing 1, initially, the pivot member 3 is pivoted about the pivot axis (X), which is at the position (XP_{3,4}), in a counterclockwise direction from the fourth position (P₄) to an intermediate fifth position (not shown) such that the positioning rod 33 of each pivot block 32 of the pivot member 3 moves upwardly and rearwardly in the second slot portion 42 of the guiding slot 40 in the corresponding guiding member 4 until the positioning rod 33 of each pivot block 32 of the pivot member 3 abuts against a lower portion of the first guiding face 422 of the corresponding guiding member 3. In other words, during pivoting of the pivot member 3 from the fourth position (P₄) to the fifth position, the positioning rod 33 of each pivoting block 32 of the pivot member 3 moves along a path (S4).

Subsequently, the pivot member 3 is continuously pivoted about the pivot axis (X) in the counterclockwise direction from the fifth position to the first position (P₁). Hence, the positioning rod 33 of each pivoting block 32 of the pivot member 3 is in slidable contact with the first guiding face 422 of the corresponding guiding member 4, and moves along a path (S5) in the second slot portion 42 of the guiding slot 40 in the corresponding guiding member 4, thereby resulting in frontward movement of the pivot axis (X) from the position (XP_{3,4}) to the position (XP_{1,2}). Since the detachable module 2 undergoes corresponding forward movement at this time, the connector 21 of the detachable module 2 is disconnected from the selected connecting port 12 of the housing 1, as shown in FIG. 4.

Thereafter, the detachable module 2 can be moved away from the housing 1 by operating the pivot member 3 to move frontwardly to thereby result in the positioning rods 33 moving along the path (S0) in the first slot portions 31 of the guiding slots 30 in the guiding members 3.

In such a configuration, the positioning device of the present invention enables the detachable module 2 to be easily positioned in and detached from the housing 1 without the need for tools, thereby resulting in convenience during assembly and disassembly. Furthermore, due to the presence of the first and second guiding faces 422, 421 of the guiding members 4, proper electrical connection between the connector 21 of the detachable module 2 and the selected connecting port 12 of the housing 1 can be ensured, thereby reducing damage to the connector 21 and the selected connecting port 12 during assembly.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A positioning device adapted for positioning a detachable module in a housing, the housing having a front open side, said positioning device comprising:
a pair of guiding members adapted to be mounted fixedly in the housing and spaced apart from each other in a direction, each of said guiding members being formed with a hook-shaped guiding slot, said guiding slot in each of said guiding members having an elongate first slot portion that extends rearwardly from a front end of a corresponding one of said guiding members, and a curved second slot portion connected to said first slot portion and extending downwardly and frontwardly from a rear end of said first slot portion, each of said guiding members having curved first and second guiding faces parallel to each other and defining said second slot portion of said guiding slot in the corresponding one of said guiding members therebetween; and
a pivot member adapted to be mounted pivotally on the detachable module such that said pivot member is pivotable relative to the detachable module about an axis parallel to the direction, said pivot member having opposite pivot blocks adapted to be connected respectively and pivotally to opposite lateral sides of the detachable module, each of said pivot blocks being disposed between a corresponding one of said guiding members and the detachable module when the detachable module is inserted into the housing via the front open side, each of said pivot blocks having an integral positioning rod that extends outwardly in the direction and that has a diameter substantially equal to a distance between said first and second guiding faces of the corresponding one of said guiding members;
whereby, during assembly of the detachable module to the housing, initially, said positioning rods of said pivot blocks of said pivot member are guided respectively by said first slot portions of said guiding slots in said guiding members to move rearwardly as a result of rearward movement of the detachable module until said positioning rod of each of said pivot blocks of said pivot member abuts against said first guiding faces of the corresponding one of said guiding members, and subsequently, said pivot member is operable so as to pivot said pivot blocks of said pivot member such that said positioning rod of each of said pivot blocks of said pivot member is in slidable contact with said second guiding face of the corresponding one of said guiding members, and moves along said second slot portion of the corresponding one of said guiding members, thereby resulting in further rearward movement of the detachable module by a predetermined distance in response to continuous pivoting of said pivot member.

2. The positioning device as claimed in claim 1, wherein said pivot member further has an intermediate handgrip interconnecting fixedly said pivot blocks.
